(19) United States
(12) Patent Application Publication
(10) Pub. No.: US 2026/0015899 A1
(43) Pub. Date: Jan. 15, 2026

(54) HINGE MOUNTING STRUCTURE FOR VEHICLE

(71) Applicants: HYUNDAI MOTOR COMPANY, SEOUL (KR); KIA CORPORATION, SEOUL (KR)

(72) Inventor: Woo-Dong Hwang, Hwaseong-si (KR)

(73) Assignees: HYUNDAI MOTOR COMPANY, SEOUL (KR); KIA CORPORATION, SEOUL (KR)

(21) Appl. No.: 18/947,550

(22) Filed: Nov. 14, 2024

(30) Foreign Application Priority Data
Jul. 15, 2024 (KR) 10-2024-0093028

(51) Int. Cl. E05D 5/02; B60J 5/04

(52) U.S. Cl. CPC E05D 5/0207; B60J 5/0479; E05Y 2900/531

(57) ABSTRACT

A hinge mounting structure for a vehicle includes a door hinge fastened to one of a door and a vehicle body of the vehicle, a mounting bracket fastened to the other of the door and the vehicle body and hinge-connected to the door hinge, and a plurality of centering bolts passing through the mounting bracket, in which the mounting bracket is formed with a reference hole that is formed in a perfect circle and formed to come into surface contact with the perimeter of the centering bolt, and the mounting bracket is formed with slot holes and formed in the form of a long hole so that a portion thereof comes into surface contact with the perimeter of the centering bolt at a location spaced apart from the reference hole.

### CROSS REFERENCE TO RELATED APPLICATIONS

This application claims priority to Korean Patent Application No. 10-2024-0093028, filed on Jul. 15, 2024, which is incorporated herein by reference in its entirety.

### BACKGROUND

### Field of the Disclosure

The present disclosure relates to a hinge mounting structure for mounting a door on a vehicle body in an openable state in a vehicle, and more specifically, to a hinge mounting structure for a vehicle, which is capable of easily adjusting a step and gap between the vehicle body and the door.

### Description of Related Art

To mount a door on a vehicle, a hinge is mounted between a vehicle body of the vehicle and the door.

Typically, the hinge is formed so that the door rotates about a rotational axis perpendicular to the ground to open and close side surfaces of the vehicle.

In some vehicles, a coach door is applied to allow a passenger to easily get on or get off seats in a second row and to facilitate a sense of openness, and a center pillar is not configured. As shown in FIG. 1, the coach door is installed to rotate in a direction opposite to a front door 111 and a rear door 112.

Referring to FIG. 1, in vehicles to which the center pillar is not configured and the coach door type is installed, while the front door 111 is connected to the vehicle body at two points using a front door upper hinge 115 and a front door lower hinge 116 at upper and lower portions, respectively, the rear door 112 is fastened with a rear door hinge 120 electrically operated by a motor to provide convenience when the rear door 112 is open and closed. Since only one rear door hinge 120 is installed, the rear door hinge 120 needs to support a load of the rear door 112, so the sagging of the rear door 112 increases.

As a constant gap is formed between the perimeter of the rear door 112 and the vehicle body when the rear door 112 is closed, it is not easy to prevent the occurrence of a step. To solve this, as shown in FIGS. 3-5, when a mounting bracket 121 installed at one side of the rear door hinge 120 is mounted on the vehicle body using a centering bolt 130, clearance between a fastening hole 122 formed in the mounting bracket 121 and the centering bolt 130 is minimized. The fastening holes 122 are formed at intervals in a height direction of a vehicle 100 in the mounting bracket 121, and the centering bolt 130 is fastened to each of the fastening holes 122 so that the rear door hinge 120 to which the rear door 112 is fastened is fastened to the vehicle body of the vehicle. The centering bolt 130 includes a head 131, a spiral portion 132 formed with a screw thread, and a centering washer portion 133 formed between the head 131 and the spiral portion 132 so that the centering bolt 130 is positioned at the center of the fastening hole 122. To prevent the sagging of the rear door 112, all of the fastening holes 122 should be formed in a perfect circle, and a tolerance between an inner diameter d of the fastening hole 122 and an outer diameter D of the centering washer portion 133 should be minimized.

However, this acts as a factor that makes it difficult to adjust the rear door 112. As shown in FIG. 4, since a gap between the fastening hole 122 and the centering washer portion 133 is not present or very small, the attitude of the mounting bracket 121 cannot be adjusted. Since the mounting bracket 121 cannot be adjusted with respect to the vehicle body, when the gap between the perimeter of the rear door 112 and the vehicle body is not constant or the outer surface of the rear door 112 and the vehicle body have different heights at the time of mounting the rear door 112, it is difficult to adjust the attitude of the rear door 112. To forcibly adjust the rear door 112, a striker to which a latch of the rear door 112 is fixed needs to be hit using a tool, or several workers need to hold and twist the rear door 112 to change the shape of the rear door 112.

In this way, it can be difficult and cumbersome to adjust the rear door 112, and even when the adjustment is made, the adjustment of the rear door 112 is not completely completed.

### SUMMARY

The present disclosure has been invented to solve the above problems and is directed to providing a hinge mounting structure for a vehicle, which is capable of preventing the sagging of a door in a vehicle to which a coach door is applied and adjusting the attitude of the door.

A hinge mounting structure for a vehicle according to the present disclosure includes a door hinge fastened to one of a door and a vehicle body of the vehicle, a mounting bracket fastened to the other of the door and the vehicle body and hinge-connected to the door hinge, and a plurality of centering bolts passing through the mounting bracket, wherein the mounting bracket is formed with a reference hole that is formed in a perfect circle and formed to come into surface contact with a circumference of the centering bolt, and the mounting bracket is formed with a slot hole formed in the form of a long hole so that a portion thereof comes into surface contact with the circumference of the centering bolt at a location spaced apart from the reference hole.

The slot hole is formed in a long hole in a direction perpendicular to a direction in which the slot hole is disposed from the reference hole.

The slot hole is formed upward or downward in a height direction of the vehicle from the reference hole.

The slot hole includes an upper slot hole formed above the reference hole, and a lower slot hole formed under the reference hole.

The centering bolt includes a head, a spiral portion formed with a screw thread, and a centering washer portion formed between the head and the spiral portion and formed to have an outer diameter larger than an outer diameter of the spiral portion, and a perimeter of the centering washer portion comes into contact with inner surfaces of the reference hole and the slot hole.

A rack gear portion is formed in an inner surface of the slot hole, and a perimeter of the centering washer portion formed between a head and a spiral portion of the centering bolt is formed in a shape of a tooth engaged with the rack gear portion.

The centering bolt is inserted by being fitted into the reference hole as transition fit or tight fit.

An auxiliary hole through which the centering bolt passes is further formed at one side of the mounting bracket.

The auxiliary hole is formed at a side of the reference hole of the mounting bracket.

An inner diameter of the auxiliary hole is formed to be larger than an inner diameter of the reference hole.

The centering bolt is inserted by being loosely fitted into the auxiliary hole.

The door hinge is fastened to the door, and the mounting bracket is fastened to the vehicle body.

The door is a rear door of which a rear end is hinge-connected to the vehicle body of the vehicle.

The vehicle does not adopt a center pillar between a front door and the rear door.

According to the hinge mounting structure for a vehicle of the present disclosure having the above configuration, it is possible to prevent the sagging of the door through the reference hole and easily adjust the attitude of the door through the slot holes vertically formed in the reference hole. Therefore, the door can be automatically mounted.

In addition, by additionally forming the auxiliary hole so that the fastened portion of the mounting bracket and the vehicle body is increased, it is possible to improve the rigidity of the fastened portion of the mounting bracket and distribute the load applied to each fastened portion, thereby increasing fastening strength.

### BRIEF DESCRIPTION OF THE FIGURES

FIG. 1 is a side view showing a state in which a door is open in a vehicle in the related art to which a coach door is applied without a center pillar.

FIG. 2 is a side view showing a state in which a hinge for mounting the door is applied to the vehicle of FIG. 1.

FIG. 3 is a schematic view showing a state in which a door hinge is mounted on a door in a vehicle to which a hinge mounting structure according to the related art is applied.

FIG. 4 is a schematic view showing the fastening relationship between a mounting bracket and a centering bolt in the vehicle to which the hinge mounting structure according to the related art is applied.

FIG. 5 is a cross-sectional view showing the fastening relationship between the mounting bracket and the centering bolt in the hinge mounting structure according to the related art.

FIG. 6 is a perspective view showing a state in which a mounting bracket is assembled to a door hinge in a vehicle hinge mounting structure according to the present disclosure.

FIG. 7 is a schematic view showing the fastening relationship between the mounting bracket and a centering bolt in the hinge mounting structure for a vehicle according to the present disclosure.

FIG. 8 is a cross-sectional view showing the fastening relationship between the mounting bracket and the centering bolt in the hinge mounting structure for a vehicle according to the present disclosure.

FIG. 9 is a cross-sectional view along line A-A in FIG. 8.

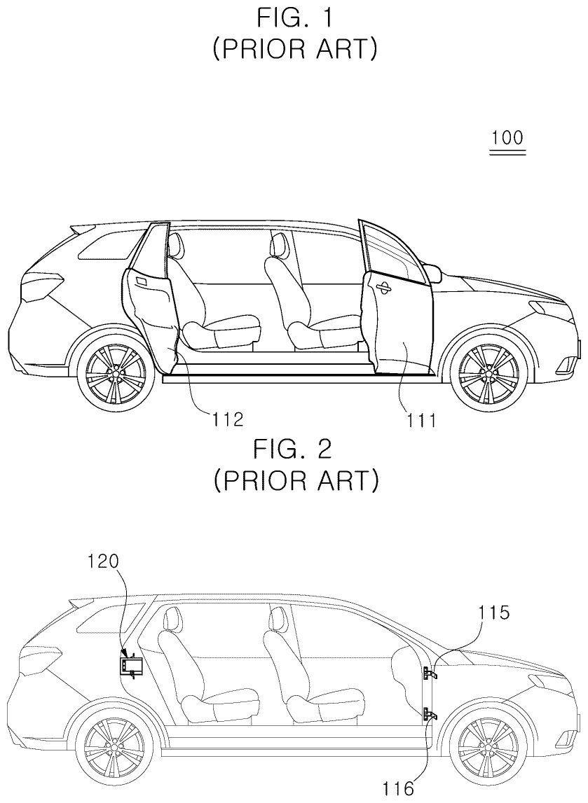

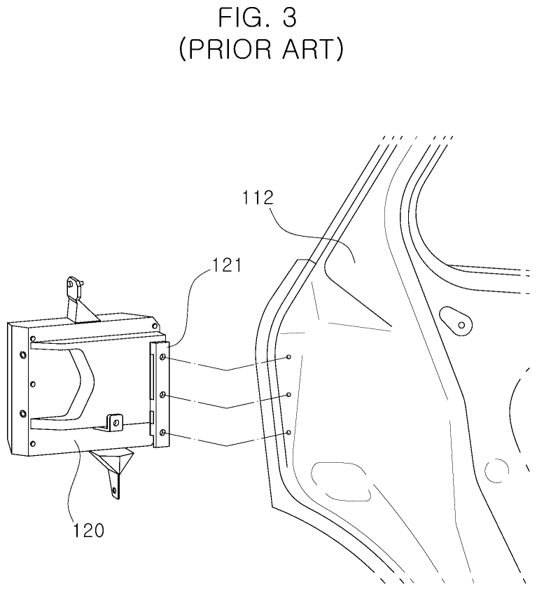

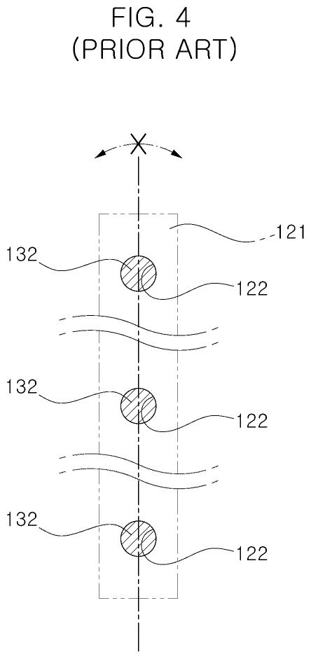

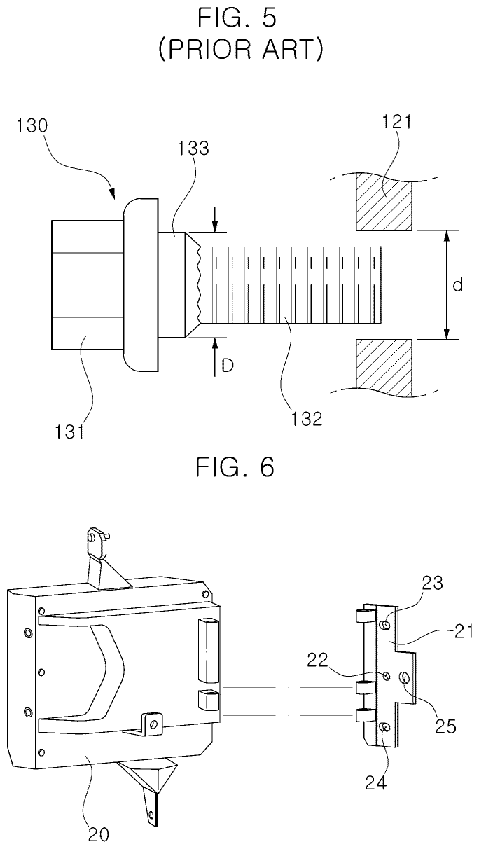

### DETAILED DESCRIPTION

Hereinafter, a hinge mounting structure for a vehicle according to the present disclosure will be described in detail with reference to the accompanying drawings.

The hinge mounting structure for a vehicle according to the present disclosure includes a door hinge 20 fastened to one of a door and a vehicle body of the vehicle, a mounting bracket 21 fastened to the other of the door and the vehicle body and hinge-connected to the door hinge 20, and a plurality of centering bolts 30 passing through the mounting bracket 21, in which the mounting bracket 21 is formed with a reference hole 22 that is formed in a perfect circle and formed to come into surface contact with the perimeter of the centering bolt 30, and the mounting bracket 21 is formed with slot holes 23 and 24 formed in the form of a long hole so that a portion thereof comes into surface contact with the perimeter of the centering bolt 30 at a location spaced apart from the reference hole 22.

The hinge mounting structure for a vehicle according to the present disclosure is used to a door hinge that installs a vehicle door on a vehicle body.

The present disclosure is used to a vehicle that installs a coach door in which a front door and a rear door of the vehicle are opened and closed in opposite directions. That is, the coach door is formed so that a front door has a front end hinge-connected to the vehicle body and a rear door has a rear end hinge-connected to the vehicle body, and the present disclosure is applied to the vehicle in which such a coach door is installed.

In this case, the present disclosure is preferably used to the door hinge that hinge-connects the rear door among the front door and the rear door to the vehicle body to the vehicle body.

In particular, the present disclosure is used to a vehicle in which there is no center pillar between the front door and the rear door in the vehicle body. When no center pillar is present, it is not easy to fix the front end of the rear door when the rear door is closed, thereby resulting in an increase in sagging.

Therefore, the hinge mounting structure for a vehicle according to the present disclosure is preferably used to the door hinge 20 that mounts the rear door on the vehicle body in the vehicle to which the coach door is not configured the center pillar.

The door hinge 20 and the mounting bracket 21 are hinge-connected and fastened to the door and the vehicle body of the vehicle, respectively. For example, the door hinge 20 is fastened to the door, and the mounting bracket 21 is fastened to the vehicle body. Since the door hinge 20 and the mounting bracket 21 are hinge-connected, the door hinge 20 and the mounting bracket 21 are fastened to the door and the body, respectively, so that the door is mounted on the vehicle body.

Hereinafter, a case in which the door hinge 20 is fastened to the door and the mounting bracket 21 is fastened to the vehicle body will be described as an example.

Meanwhile, the door hinge 20 may be fastened to the vehicle body, and the mounting bracket 21 may be fastened to the door.

The hinge mounting structure for a vehicle according to the present disclosure supports the load of the door on the mounting bracket 21 when the mounting bracket 21 is fastened to prevent the sagging of the door and adjusts the attitude of the door.

To this end, the reference hole 22 and the slot holes 23 and 24 are formed in the mounting bracket 21 so that the centering bolt 30 passes through the mounting bracket 21.

The reference hole 22 is formed at one side of the mounting bracket 21. The reference hole 22 is formed in a perfect circle, and the centering bolt 30 passes through the reference hole 22 so that the perimeter of the centering bolt 30 comes into surface contact with the reference hole 22.

Since the reference hole 22 is formed in a perfect circle and the outer perimeter of the centering bolt 30 comes into contact with an inner surface of the reference hole 22, the mounting bracket 21 may hold a predetermined location from the vehicle body.

The centering bolt 30 includes a head 31 for tightening the centering bolt 30 using a tool, a spiral portion 32 formed with a screw thread formed so that the centering bolt 30 is fastened to a nut, and a centering washer portion 33 formed so that the centering bolt 30 comes into contact with the inner circumference of a hole such as the reference hole 22 between the head 31 and the spiral portion 32.

Since the centering bolt 30 is fitted into the reference hole 22 so that the circumference of the centering washer portion 33 of the centering bolt 30 comes into contact with the inner surface of the reference hole 22, the mounting bracket 21 may hold a predetermined location.

For example, the centering washer portion 33 of the centering bolt 30 is inserted by being fitted into the reference hole 22 as transition fit or tight fit.

The slot holes 23 and 24 are formed in the form of a long hole at a location spaced apart from the reference hole 22 of the mounting bracket 21.

The slot holes 23 and 24 are formed as long holes in a direction perpendicular to a direction in which the slot holes 23 and 24 are disposed from the reference hole 22.

In addition, the slot holes 23 and 24 are located upward or downward in a height direction of the vehicle from the reference hole 22 to prevent the sagging of the door.

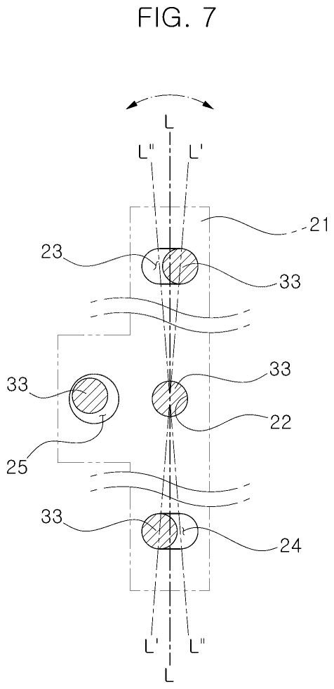

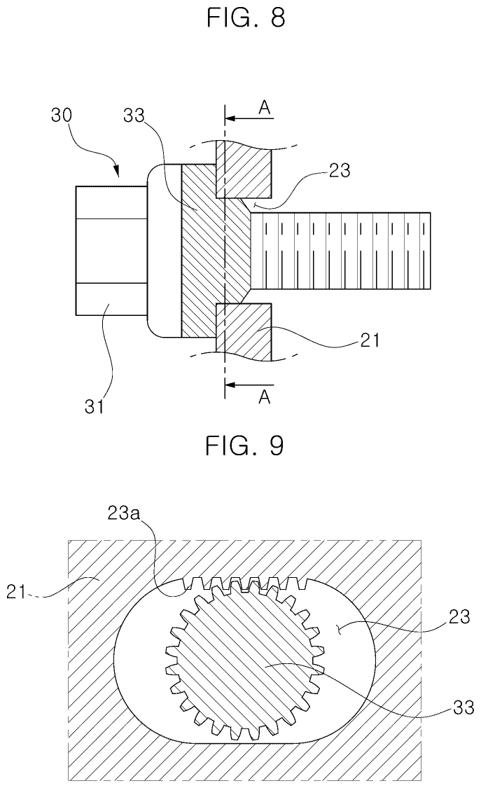

In this way, since each of the slot holes 23 and 24 are formed above or under the reference hole 22, the long holes formed in the slot holes 23 and 24 are formed in a left-right direction of the drawings as shown in FIGS. 6 and 7.

In particular, the slot holes 23 and 24 are formed as an upper slot hole 23 and a lower slot hole 24 above and under the reference hole 22. That is, the upper slot hole 23 is formed above the reference hole 22, and the lower slot hole 24 is formed under the reference hole 22. In this case, the center of the reference hole 22 is located on a virtual line that connects the center of the upper slot hole 23 to the center of the lower slot hole 24. For example, in FIG. 7, the center of the reference hole 22 is located on a virtual straight line L that connects the center of the upper slot hole 23 to the center of the lower slot hole 24.

In addition, the upper slot hole 23 and the lower slot hole 24 are formed as long holes in a direction perpendicular to the straight line L.

Meanwhile, the centering bolt 30 is inserted by passing through the upper slot hole 23 and the lower slot hole 24 and is fastened to a nut inside the vehicle body.

Since the upper slot hole 23 and the lower slot hole 24 are formed in the form of a long hole, the mounting bracket 21 rotates at a predetermined angle with respect to the vehicle body to adjust the attitude of the door with respect to the vehicle body.

That is, as shown in FIG. 7, the mounting bracket 21 may rotate about the reference hole 22 to both left and right sides at a predetermined angle so that the straight line L becomes a straight line L′ or a straight line L″, thereby easily adjusting the attitude of the door.

Here, the centering bolt 30 is inserted into the upper slot hole 23 and the lower slot hole 24, and when the centering bolt 30 passes through the upper slot hole 23 and the lower slot hole 24, the centering bolt 30 is engaged with the upper slot hole 23 and the lower slot hole 24. That is, a rack gear portion 23a is formed in each of the upper slot hole 23 and the lower slot hole 24 that are formed in the form of a long hole, and the centering washer portion 33 of the centering bolt 30 has a shape of a tooth on the outer circumference. Therefore, the centering bolt 30 is engaged with the upper slot hole 23 and the lower slot hole 24 (see FIG. 9). Although FIG. 9 shows a configuration in which the rack gear portion 23a is formed in the upper slot hole 23, the rack gear portion is also formed in the lower slot hole 24. Here, the rack gear portion is formed on upper surfaces of the upper slot hole 23 and the lower slot hole 24 to facilitate the adjustment of the step and gap between the vehicle body and the door.

In addition, since the centering washer portion 33 is engaged with the rack gear portion 23a, a fastened and contacting area increases, thereby increasing fastening strength.

With this structure, when the mounting bracket 21 is engaged with the vehicle body of the vehicle using the centering bolt 30, the mounting bracket 21 may rotate relatively with respect to the vehicle body to adjust the attitude of the door.

An auxiliary hole 25 is additionally formed at a location spaced apart from the reference hole 22 of the mounting bracket 21. The auxiliary hole 25 is formed to have an inner diameter larger than an inner diameter of the reference hole 22 at a location spaced apart from the reference hole 22. The centering bolt 30 for fastening the mounting bracket 21 to the vehicle body also passes through the auxiliary hole 25 so that the centering bolt 30 is fastened inside the vehicle body, thereby increasing the fastening strength of the mounting bracket 21.

In particular, the inner diameter of the auxiliary hole 25 is formed larger than an outer diameter of the centering bolt 30 so that the centering bolt 30 passes through the auxiliary hole 25 to be loosely fitted therein, thereby easily adjusting the attitude of the door.

The auxiliary hole 25 is preferably formed at the side of the reference hole 22 of the mounting bracket 21. Since the upper slot hole 23 and the lower slot hole 24 of the mounting bracket 21 are formed above and under the reference hole 22, the auxiliary hole 25 is preferably formed at the side of the reference hole 22.

While the present disclosure has been described with reference to the accompanying drawings, it will be apparent to those skilled in the art that various changes and modifications can be made without departing from the spirit and scope of the present disclosure without being limited to the exemplary embodiments disclosed herein. Accordingly, it should be noted that such alternations or modifications fall within the claims of the present disclosure, and the scope of the present disclosure should be construed on the basis of the appended claims.

1. A hinge mounting structure for a vehicle, comprising:
a door hinge fastened to one of a door and a vehicle body of the vehicle;
a mounting bracket fastened to an other of the door and the vehicle body, and connected to the door hinge; and
a plurality of centering bolts passing through the mounting bracket;
wherein the mounting bracket has a circular reference hole that contacts a circumference of each of the plurality of centering bolts; and
wherein the mounting bracket has a slot hole formed as a long hole that contacts the circumference of each of the centering bolts at a location spaced apart from the circular reference hole.

2. The hinge mounting structure of claim 1, wherein the slot hole is formed as a long hole in a direction perpendicular to a direction in which the slot hole is positioned from the circular reference hole.

3. The hinge mounting structure of claim 1, wherein the slot hole is formed upward or downward in a height direction of the vehicle from the circular reference hole.

4. The hinge mounting structure of claim 3, wherein the slot hole includes:
an upper slot hole formed above the circular reference hole; and
a lower slot hole formed under the circular reference hole.

5. The hinge mounting structure of claim 1, wherein each of the plurality of centering bolts includes:
a head;
a spiral portion formed with a screw thread; and
a centering washer portion formed between the head and the spiral portion, and having an outer diameter larger than an outer diameter of the spiral portion; and
wherein a perimeter of the centering washer portion contacts inner surfaces of both the circular reference hole and the slot hole.

6. The hinge mounting structure of claim 1, wherein a rack gear portion is formed in an inner surface of the slot hole, and
wherein a perimeter of a centering washer portion formed between a head and a spiral portion of each of the plurality of centering bolts is formed in a shape of a tooth engaged with the rack gear portion.

7. The hinge mounting structure of claim 1, wherein each of the plurality of centering bolts is inserted by being fitted into the reference hole by transition fit or tight fit.

8. The hinge mounting structure of claim 1, wherein an auxiliary hole through which each of the plurality of centering bolts passes is further formed at one side of the mounting bracket.

9. The hinge mounting structure of claim 8, wherein the auxiliary hole is formed at a side of the reference hole of the mounting bracket.

10. The hinge mounting structure of claim 8, wherein an inner diameter of the auxiliary hole is larger than an inner diameter of the reference hole.

11. The hinge mounting structure of claim 8, wherein each of the plurality of centering bolts is configured to be loosely inserted into the auxiliary hole.

12. The hinge mounting structure of claim 1, wherein the door hinge is fastened to the door, and
the mounting bracket is fastened to the vehicle body.

13. The hinge mounting structure of claim 1, wherein the door is a rear door of which a rear end is hinge-connected to the vehicle body of the vehicle.

14. The hinge mounting structure of claim 13, wherein the vehicle does not include a center pillar between a front door and the rear door.
